(19) United States
(12) Patent Application Publication
(10) Pub. No.: US 2016/0350039 A1
(43) Pub. Date: Dec. 1, 2016

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Yoshinori Yamaguchi, Yamato-shi (JP)

(21) Appl. No.: 15/162,949

(22) Filed: May 24, 2016

(30) Foreign Application Priority Data
May 29, 2015 (JP) 2015-110454

(51) Int. Cl. G06F 3/12; H04W 48/20

(52) U.S. Cl. CPC G06F 3/1236; H04W 48/20; G06F 3/1286; H04W 84/12

(57) ABSTRACT

In an information processing apparatus that commands a communication device having a wireless LAN communication function to search for an access point and acquires results of the search, appropriate search results based on a sufficient search are acquired from the communication device. An information processing apparatus that controls a communication device, including: a command unit configured to command the communication device to search for an access point to which the communication device can connect; a first acquisition unit configured to acquire identification information indicating the completion of the access point search performed by the communication device; and a second acquisition unit configured to acquire results of the access point search performed by the communication device in accordance with the command issued by the command unit.

### BACKGROUND OF THE INVENTION

Field of the Invention

The present invention relates to an information processing apparatus, a control method, and a storage medium.

Description of the Related Art

In the case where a communication device having a wireless LAN communication function acquires information on a connectable wireless LAN access point, information is transmitted and received to and from an information processing apparatus (host equipment) that gives various instructions to the communication device. For example, Japanese Patent Laid-Open No. 2006-050587 has disclosed the technique to automatically complete a network connection setting between the communication device and the access point by reflecting the wireless LAN network setting between the information processing apparatus and the access point. With this technique, in the configuration in which the communication device and the information processing apparatus are connected by a wired interface, such as USB, first, the information processing apparatus transmits a search command to the communication device via the wired interface to search for a connectable access point. Then, the communication device having received the search command searches for a connectable access point and the search results are returned to the information processing apparatus.

In the above-described technique, it is not possible to know whether the search results returned from the communication device are those based on a sufficient search on the information processing apparatus side. Because of this, there is a possibility that the acquired search results are insufficient contents (there exists an access point not detected despite the communication device can connect to it).

### SUMMARY OF THE INVENTION

The information processing apparatus according to the present invention is an information processing apparatus that controls a communication device and includes a command unit configured to command the communication device to search for an access point to which the communication device can connect, a first acquisition unit configured to acquire identification information indicating the completion of the access point search performed by the communication device, and a second acquisition unit configured to acquire results of the access point search performed by the communication device in accordance with the command issued by the command unit, and the first acquisition unit acquires the identification information before the issuance of the command by the command unit and after the issuance of the command by the command unit, and the second acquisition unit determines whether or not to acquire results of the access point search based on the identification information acquired by the first acquisition unit before the issuance of the command by the command unit and the identification information acquired by the first acquisition unit after the issuance of the command by the command unit.

Further features of the present invention will become apparent from the following description of exemplary embodiments (with reference to the attached drawings).

### BRIEF DESCRIPTION OF THE DRAWINGS

FIGS. 1A and 1B are diagrams each showing an entire configuration of a printing system;

FIG. 2 is a diagram showing an example of a hardware configuration of an information processing apparatus;

FIG. 3 is a diagram showing an example of a hardware configuration of a communication device;

FIG. 4 is a diagram showing a software configuration in the information processing apparatus;

FIG. 5 is a diagram showing a configuration of an MIB in the communication device;

FIG. 6 is a flowchart showing a flow of control processing until search results are acquired by causing the communication device to search for an access point according to a first embodiment;

FIG. 7 is a diagram showing an example in the case where search results acquired from the communication device are displayed on a UI screen; and

FIG. 8 is a flowchart showing a flow of control processing until search results are acquired by causing a communication device to search for an access point according to a second embodiment.

### DESCRIPTION OF THE EMBODIMENTS

### First Embodiment

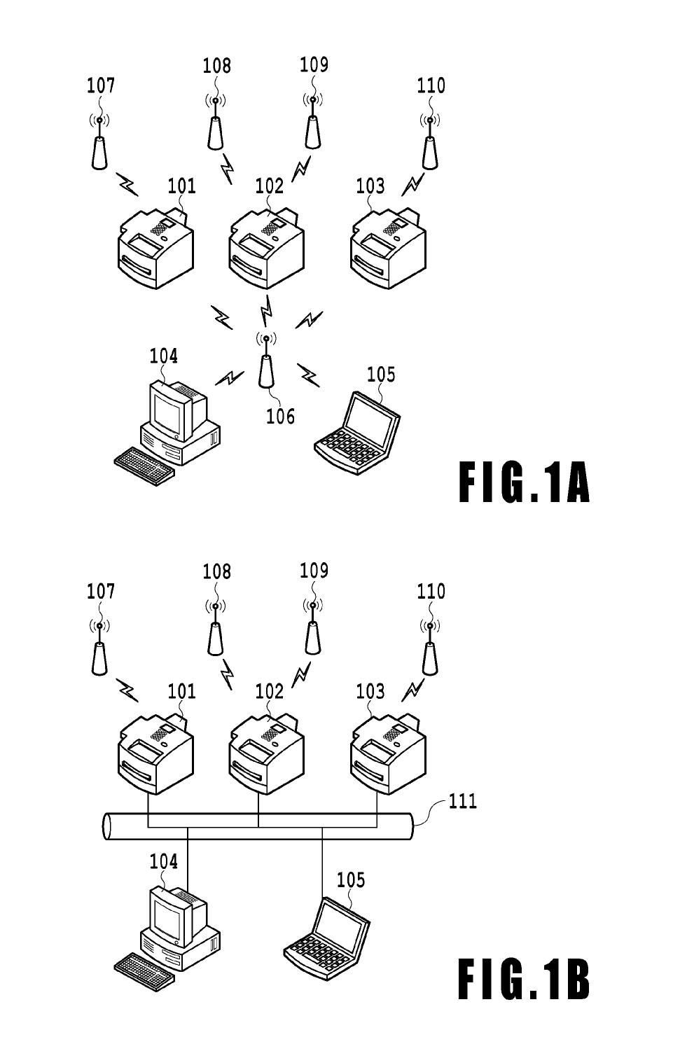

First, an entire configuration of a printing system according to the present embodiment is explained. FIG. 1A shows an entire configuration of a printing system in which communication devices and information processing apparatuses, which are host equipment of the communication devices, are connected and FIG. 1B shows an entire configuration of a printing system in which communication devices and information processing apparatuses are connected differently from that in the printing system in FIG. 1A.

The printing system shown in FIG. 1A includes three communication devices 101 to 103 each having a wireless LAN communication function and two information processing apparatuses 104 and 105 capable of communication with the three communication devices through a wireless LAN. Then, as an access point of the wireless LAN that can connect the communication devices 101 to 103 and the information processing apparatuses 104 and 105, access points 106 to 110 at five positions are shown. In FIG. 1A, the communication devices 101 to 103 and the information processing apparatuses 104 and 105 are connected to the wireless LAN via the access point 106 and it is possible for each information processing apparatus to control the communication devices 101 to 103 through the wireless LAN. It is also possible for each communication device to establish connection through the wireless LAN via the other access points 107 to 110 in place of the access point 106 to which each communication device is being connected currently.

In the printing system shown in FIG. 1B, the three communication devices 101 to 103 and the two information processing apparatuses 104 and 105 are connected via a wired LAN cable 111 in place of the access point 106. The difference between FIG. 1A and FIG. 1B lies only in that each information processing apparatus and each communication device are connected through the wireless LAN or through the wired LAN.

### <<Hardware Configuration of Information Processing Apparatus>>

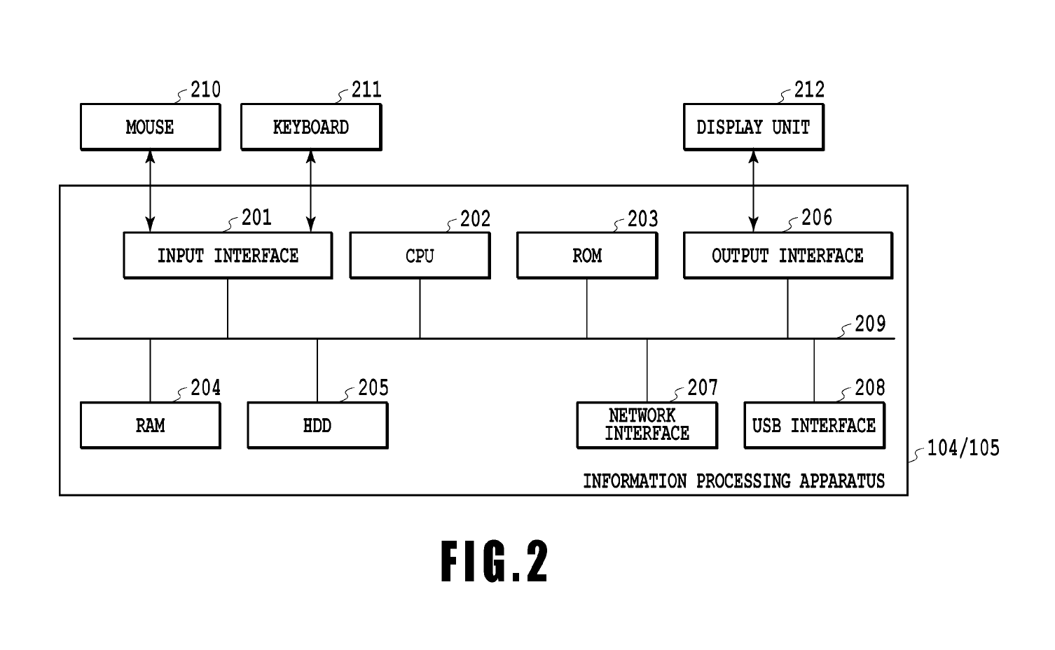

FIG. 2 is a diagram showing an example of a hardware configuration of the information processing apparatus 104/105.

Each information processing apparatus includes an input interface 201, a CPU 202, a ROM 203, a RAM 204, an external storage device (here, HDD) 205, an output interface 206, a network interface 207, and a USB interface 208. Then, each unit is connected to one another via a system bus 209.

The input interface 201 is an interface that controls connection with an input device, such as a mouse 210 and a keyboard 211. The output interface 206 is an interface that controls connection with a display unit 212, such as a liquid crystal display. The network interface 207 is an interface that controls connection to the wireless LAN via the access point 106 or connection to the wired LAN via the wired LAN cable 111. The USB interface 208 is an interface that controls USB connection via a USB cable.

In the ROM 203, an initialization program is stored and in the HDD 205, a group of application programs, an OS (Operating System), a printer driver, and other various kinds of data are stored. The RAM 204 is used as a work memory in the case where the CPU 202 executes various programs.

The above-described hardware configuration is an example and the hardware configuration of the information processing apparatus is not limited to the example described above. Further, in the present embodiment, as the information processing apparatus, a personal computer (PC) is illustrated, but is it also possible to make use of devices, such as a mobile terminal, a smartphone, a tablet terminal, and a PDA (Personal Digital Assistant).

### <<Hardware Configuration of Communication Device>>

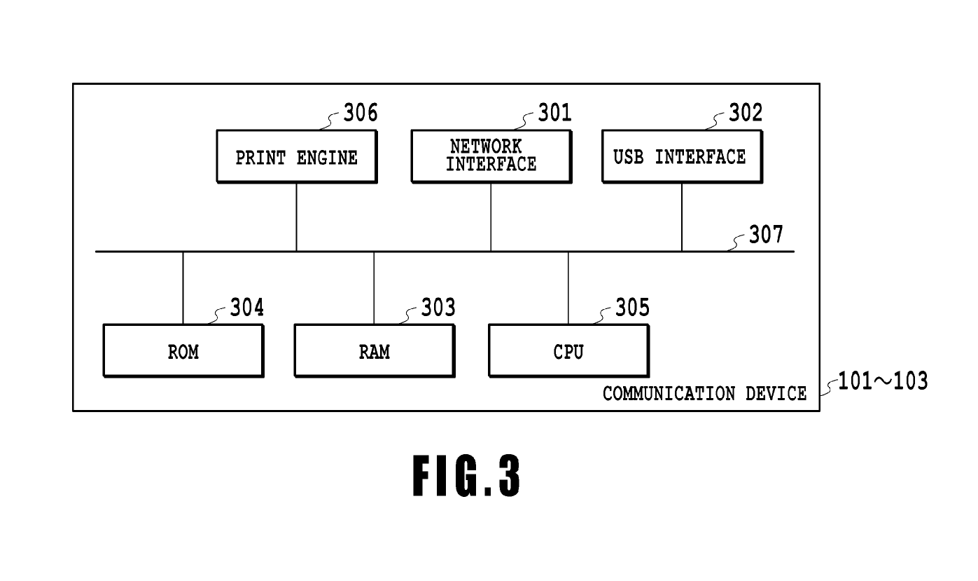

FIG. 3 is a diagram showing an example of the hardware configuration of the communication devices 101 to 103.

Each communication device includes a network interface 301, a USB interface 302, a RAM 303, a ROM 304, a CPU 305, and a print engine 306. Then, each unit is connected to one anther via a system bus 307.

The network interface 301 is an interface that controls connection to the wireless LAN via the access point 106 or connection to the wired LAN via the wired LAN cable 111. The USB interface 302 is an interface that controls USB connection via a USB cable.

The RAM 303 is used as a main memory and a work memory of the CPU 305 and functions as a reception buffer for temporarily saving received print data and as a storage area for saving various kinds of data. The print engine 306 performs printing based on the print data that is saved in the RAM 303 and the print job that is received from an external device, such the information processing apparatus. At this time, the print engine 306 forms an image on a printing medium, such as paper, an OHP sheet, and a film, not shown schematically, which are included in the communication device by using a printing material, such as ink, not shown schematically, which is included in the communication device. In the ROM 304, various control programs and data used by each of the control programs are stored, and the CPU 306 controls each unit of the communication device in accordance with these control programs.

The above-described hardware configuration is an example and the hardware configuration of the communication device is not limited to the above-described example. In the present embodiment, as the communication device, an ink jet multi function printer is illustrated, but it is possible to make use of various devices provided that they communicate with the information processing apparatus and are capable of displaying a connectable access point. For example, as the communication device, it is possible to make use of an image processing apparatus other than the ink jet printer, a PC, a mobile terminal, a smartphone, a tablet terminal, a PDA, a digital camera, a television, a scanner, etc. The image processing apparatus other than the ink jet printer includes, for example, a full-color laser beam printer that uses toner as a printing material, a monochrome printer, a device, such as a copy machine and a facsimile machine. Further, each of the apparatuses, devices, and machines may be a multi function one or a single function one.

### <<Software Configuration of Information Processing Apparatus>>

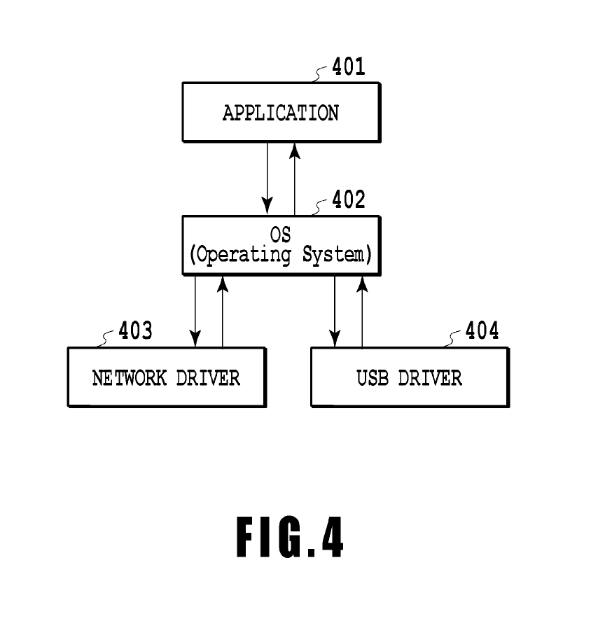

FIG. 4 is a diagram showing a software configuration for acquiring search results by commanding the communication devices 101 to 103 to search for an access point in the information processing apparatus 104/105. An application 401 creates a command (search start command) to search for a connectable wireless LAN access point, which is to be transmitted to the communication devices 101 to 103. The created search start command is transmitted to the communication device 101 to 103 via an API (Application Programming Interface) provided by an OS 402. In the case of being connected with the transmission destination communication device through the wired LAN or the wired LAN as in the present embodiment, the search start command is transmitted by controlling a network driver 403. In the case of being connected with the transmission destination communication device via the USB, the API of the OS 402 transmits the search start command by controlling a USB driver 404.

### <<Software Configuration of Communication Device>>

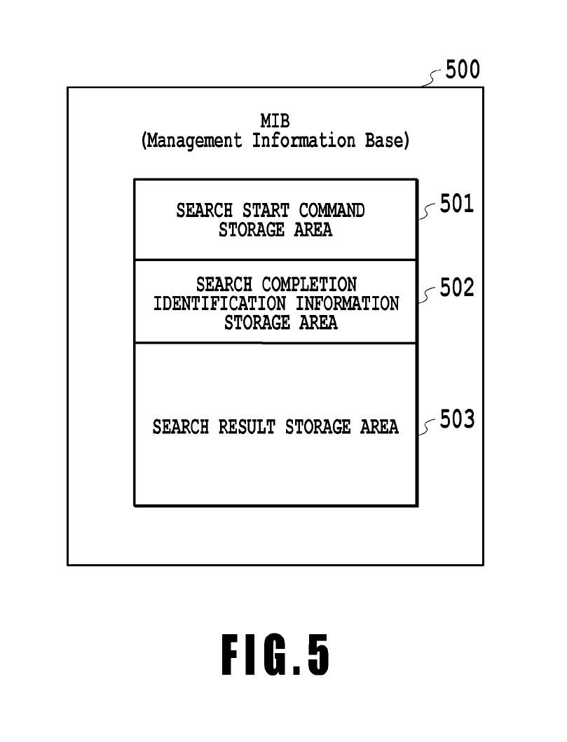

FIG. 5 is a diagram showing a configuration of an MIB (Management Information Base) that manages wired LAN and wireless LAN communication in the communication devices 101 to 103. An MIB 50 is one kind of database for managing a device in a communication network and is provided, for example, on the RAM 303. In the MIB 500, as data storage areas relating to the access point search of the wireless LAN, a search start command storage area 501, a search completion identification information storage area 502, and a search result storage area 503 exist. In the search start command storage area 501, a search command (search start command) received from the information processing apparatus 104/105 is stored. In the case where a search start command is stored in the search start command storage area 501, processing to search for an access point is performed in the communication device. In the search completion identification information storage area 502, search completion identification information that is information indicating that the processing to search for an access point is completed is stored/held. In the search result storage area 503, information on a list of access points detected by the search processing is stored.

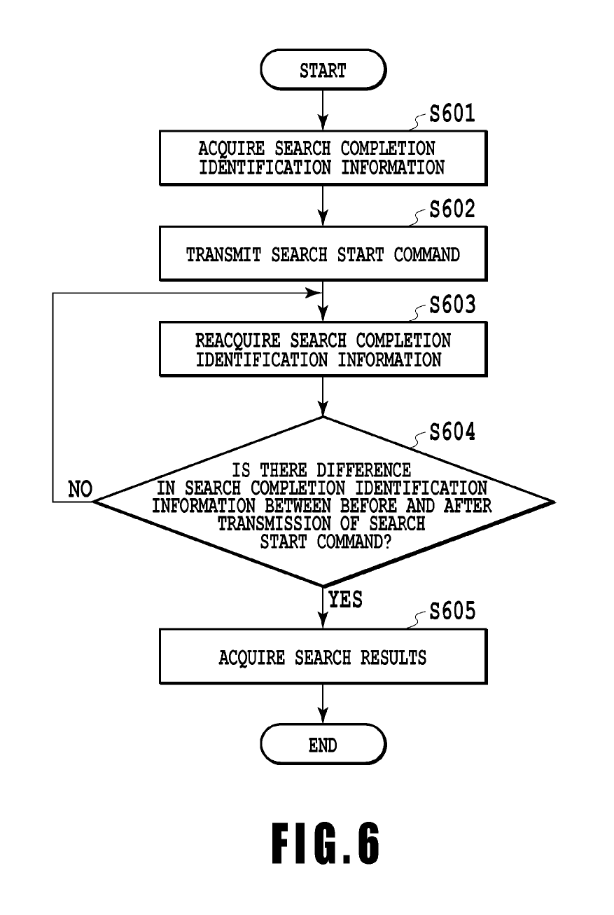

Subsequently, control by the application 401 of the information processing apparatus 104/105 until search results are acquired by causing the communication device to search for an access point is explained. FIG. 6 is a flowchart showing a flow of control processing until search results are acquired by causing the communication device to search for an access point according to the present embodiment. The control processing is implemented by the CPU 202 executing a predetermined program after reading the program from the ROM 203 or the RAM 204 in response to the operation instructions (instructions to search for an access point) that a user inputs by using the mouse 210 or the like. The control processing may be performed automatically at, for example, predetermined time intervals or at the time of the arrival of the information processing apparatus in place of instructions of a user.

At step 601, before the access point search start command is transmitted to the target communication device, the access point search completion identification information is acquired through the wired LAN or the wireless LAN. In the present embodiment, the search completion identification information is acquired by reading a tick count value stored within the search completion identification information storage area 502 within the MIB 500 of the target communication device. Here, the tick count value is a value indicating the elapsed time after the power source is turned on in the communication device and is updated to a value indicating the elapsed time at the point in time of the completion each time the search processing is completed. Consequently, for example, in the case where just three days have elapsed after the power source is turned on at the point in time of the completion of the most recent search processing, for example, a value of 259,200 (sec) is acquired as the search completion identification information. The unit of the tick count value is arbitrary and may be sec, msec, or min. It may be sufficient to manage the completion timing of the search processing by a method of measuring the time after the search processing starts by using a timer (not shown) or the like included in the communication device and by taking the point in time at which a predetermined time (e.g., several seconds to several tens seconds) has elapsed to be the completion timing.

At step 602, an access point search start command is generated and the generated search start command is transmitted to the target communication device by using the API of the OS 402. In the communication device, the received search start command is written in the search start command storage area 501 within the MIB 500, and thereby, the access point search processing is started.

At step 603, the access point search completion identification information is reacquired. In the present embodiment, the above-described tick count value is reacquired.

At step 604, the search completion identification information acquired at step 601 is compared with the search completion identification information reacquired at step 603 and whether there is a difference therebetween is determined. As described above, the tick count value as the search completion identification information in the present embodiment is the value indicating the elapsed time after the power source is turned on and the tick count time is updated to a new tick count value each time the search processing is completed, which is the elapsed time at the point in time of the completion, and the new tick count value is held. Consequently, in the case where the tick count value acquired before the transmission of the search start command is compared with the tick count value acquired after the transmission of the search start command and on a condition that there is a difference between both the values, it is possible to determine that the search processing corresponding to the search start command transmitted at step 602 has been completed. In the case where the results of the determination indicate that there is a difference in the tick count value between before and after the transmission of the search start command, it is determined that the search processing corresponding to the search start command transmitted at step 602 has been completed, and then, the processing proceeds to step 605. On the other hand, in the case where the results of the determination indicate that there is not a difference in the tick count value between before and after the transmission of the search start command, it is determined that the search processing corresponding to the search start command transmitted at step 602 has not been completed yet (search processing is in progress), and the processing returns to step 603. Then, the reacquisition of the search completion identification information (S603) and the tick count value comparison processing (S604) are repeated until it is determined that there is a difference in the tick count value between before and after the transmission of the search start command.

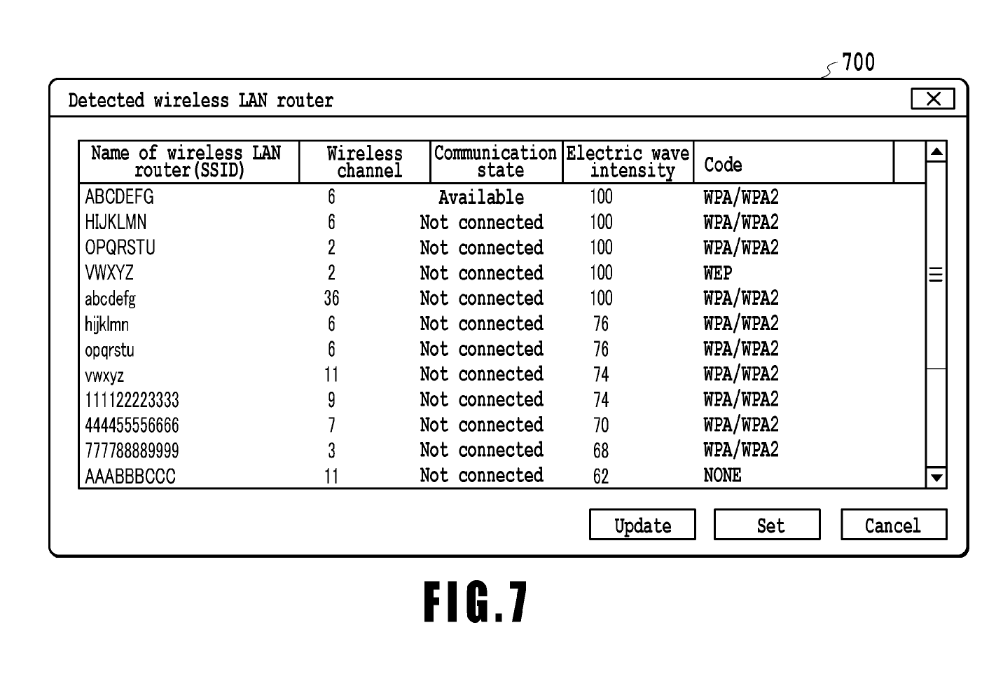

At step 605, the results of the access point search are acquired from the target communication device through the wired LAN or the wireless LAN. In the present embodiment, the search results are acquired by reading the list of information on the detected access points stored in the search result storage area 503 within the MIB 500 of the communication device. FIG. 7 is a diagram showing an example in the case where the search results acquired from the communication device by the application 401 are displayed on a UI screen of the display unit 212. On a UI screen 700, the wireless LAN routers as detected access points are displayed in a list along with information, such as electric wave intensity.

The above is the contents of the control processing until the search results are acquired by causing the communication device to search for an access point according to the present embodiment.

In the present embodiment, it is possible for the information processing apparatus to cause a user to select an access point by displaying the search results acquired by the above-described method on the display unit, not shown schematically, included in the information processing apparatus. In the case of receiving a selection of a user, the information processing apparatus transmits a command to instruct the communication device caused to search for an access point to connect to the access point selected by the user. After this, it is made possible for the information processing apparatus to communicate with a device (here, the communication device) connected to the access point by connecting the information processing apparatus itself to the access point selected by the user. Specifically, by transmitting a broadcast that requests a response to a device connected to the access point and receiving the response, the information processing apparatus recognizes the device that has returned the response as a device connected to the access point, and establishes communication with the device.

In the present embodiment, the case is explained where the information processing apparatus 104/105 and the communication devices 101 to 103 are connected through the wired LAN or the wireless LAN and the SNMP (Simple Network Management Protocol) is used as the communication protocol. However, the connection topology between the apparatus and the device is not limited to that through the wired LAN or the wireless LAN. For example, a communication topology, such as SNMP over USB, may be accepted in which the information processing apparatus and the communication device are USB-connected in a one-to-one manner.

Further, in the present embodiment, as the search completion identification information, the tick count value is used, but the search completion identification information is not limited to this. In other words, the search completion identification information only needs to be information that indicates the completion of the access point search by the communication device, and therefore, a value (e.g., 2015/0515/09:30:50) that indicates the absolute time at the point in time of the completion of the search processing may be used. In this case, on a condition that there is a difference between the absolute time acquired at step 601 and the absolute time reacquired at step 603 (on a condition that the absolute time is updated to indicate a new date and time), it is determined that the search processing has been completed. Further, the search completion identification information may be a flag that is rewritten each time the access point search is completed. In this case, on a condition that the state of the flag acquired at step 601 differs from the state of the flag reacquired at step 603, it is determined that the search processing has been completed.

According to the present embodiment, in the case where the communication device is caused to search for a connectable access point, it is possible to obtain the search results after checking the completion of the access point search based on the search completion identification information while suppressing the transmission of an unnecessary command to request acquisition of the search results.

### Second Embodiment

The first embodiment is an aspect in which in the case where search instructions are input by a user, the access point search start command is transmitted to the communication device without exception. Next, an aspect is explained as a second embodiment in which the most recent search results are acquired without transmitting the search start command in the case where not so much time has elapsed after the execution of most recent search processing at the point in time of the search instructions from a user. Explanation of the portions in common to those of the first embodiment is omitted or simplified and in the following, different points are explained mainly.

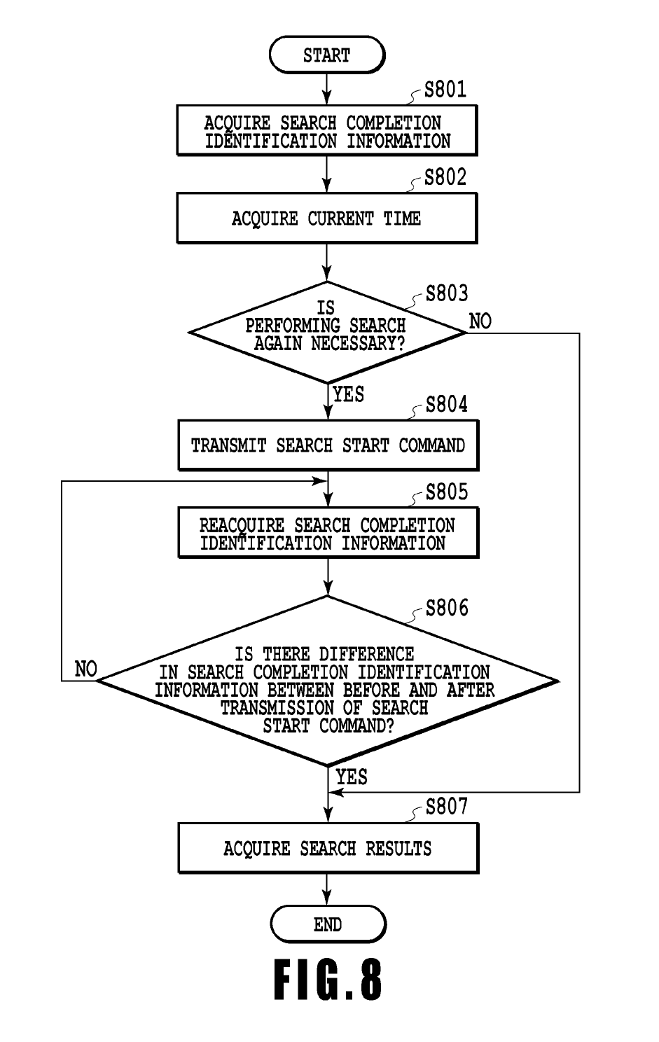

FIG. 8 is a flowchart showing a flow of control processing until search results are acquired by causing the communication device to search for an access point according to the present embodiment.

Step 801 is the same as step 601 of the first embodiment and the access point search completion identification information is acquired. In the present embodiment, it is assumed that as the search completion identification information, information on the absolute time at the point in time of the completion of the search is read and acquired from the search completion identification information storage area 502 within the MIB 500.

At step 802, information on the current time is acquired from the RTC (not shown) located within the information processing apparatus.

At step 803, whether it is necessary to search for an access point again is determined by using the absolute time at the point in time of the completion of the search (=date and time of the completion of the most recent search) as the search completion identification information acquired at step 801 and the current time acquired at step 802. Specifically, first, a difference is found by comparing the absolute time at the point in time of the completion of the search acquired at step 801 with the current time acquired at step 802 and in the case where the value (difference in time) is smaller than a predetermined threshold value (e.g., one day=36,400 sec), it is determined that performing the search again is not necessary. In the case where it is determined that performing the search again is not necessary as described above, the processing proceeds to step 807. On the other hand, in the case where the difference value that is found is greater than the predetermined value, it is determined that performing the search again is necessary and the processing proceeds to step 804.

The processing at step 804 and the subsequent steps is basically the same as that at 5602 and the subsequent steps of the first embodiment. In other words, the access point search start command is generated and transmitted to the target communication device (S804) and the access point search processing is started in the communication device. Then, at predetermined timing, the absolute time at the point in time of the completion of the access point search is reacquired (S805) and is compared with the absolute time at the point in time of the completion of the search acquired at step 801, and whether there is a difference therebetween is determined (S806). In the case where the results of the determination indicate that there is a difference in the absolute time at the point in time of the completion of the search between before and after the transmission of the search start command, it is determined that the search processing corresponding to the search start command transmitted at step 804 has been completed and the processing proceeds to step 807. On the other hand, in the case where the results of the determination indicate that there is not a difference in the absolute time at the point in time of the completion of the search between before and after the transmission of the search start command, it is determined that the search processing corresponding to the search start command transmitted at step 804 has been not been completed yet (the search processing is in progress) and the processing returns to step 805. Then, the reacquisition (S805) and the comparison processing (S806) are repeated until it is determined that there is a difference in the absolute time at the point in time of the completion of the search between before and after the transmission of the search start command. After this, the access point search results are acquired at step 807 (S807). In other words, in the case where it is determined that performing the search again is not necessary (No at S803), the most recent search results corresponding to the absolute time at the point in time of the completion of the search acquired at step 801 are acquired. On the other hand, in the case where it is determined that performing the search again is necessary (Yes at S803), the search results corresponding to the absolute time at the point in time of the completion of the search reacquired at step 805 are acquired.

The above is the contents of the control processing until the search results are acquired by causing the communication device to search for an access point according to the present embodiment.

In the present embodiment, the absolute time at the point in time of the completion of the search processing is used as the search completion identification information, but it may also be possible to use the tick count value in place of that. In this case, it is determined that the search is not necessary on a condition that the difference between the tick count value indicating the time of the completion of the most recent search acquired at step 801 and the tick count value currently in progress acquired at step 802 is shorter than a predetermined time. Further, at step 801, it may also be possible to acquire another piece of the search completion identification information that is used for the determination at step 803, in addition to the search completion identification information that is used for the determination at step 806. The other piece of the search completion identification information is, for example, a flag that is rewritten each time a predetermined time (predetermined threshold value) elapses after the date and time of the completion of the most recent search and each time the access point search is performed. With such an aspect, it is not necessary to acquire the current time at step 802 and it is possible to uniquely determine whether or not performing the search again is necessary by using the search completion identification information alone. In the case where this aspect is applied, on a condition that the state of the flag acquired at step 801 is the state that is bought about due to the elapse of a predetermined time (predetermined threshold value) after the date and time of the completion of the most recent search, it is determined that performing the search again is necessary. According to the present embodiment, only in the case where it is determined that the necessity to cause the communication device to perform the search processing is urgent, the search start command is transmitted from the information processing apparatus. Because of this, in the case of the present embodiment, it is also possible to obtain the effect that the burden of the search processing on the communication device side can be reduced, in addition to the effect of the first embodiment.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, in the information processing apparatus that acquires search results by issuing the access point search command to the communication device having the wireless LAN communication function, it is possible to acquire appropriate search results based on the sufficient search from the communication device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-110454, filed May 29, 2015, which is hereby incorporated by reference wherein in its entirety.

What is claimed is:

1. An information processing apparatus that controls a communication device, the apparatus comprising:
a command unit configured to command the communication device to search for an access point to which the communication device can connect;
a first acquisition unit configured to acquire identification information indicating the completion of the access point search performed by the communication device; and
a second acquisition unit configured to acquire results of the access point search performed by the communication device in accordance with the command issued by the command unit, wherein
the first acquisition unit acquires the identification information before the issuance of the command by the command unit and after the issuance of the command by the command unit, and
the second acquisition unit determines whether or not to acquire results of the access point search based on the identification information acquired by the first acquisition unit before the issuance of the command by the command unit and the identification information acquired by the first acquisition unit after the issuance of the command by the command unit.

2. The information processing apparatus according to claim 1, wherein
the second acquisition unit:
acquires results of the access point search in a case where the identification information acquired by the first acquisition unit before the issuance of the command by the command unit and the identification information acquired by the first acquisition unit after the issuance of the command by the command unit are different; and
does not acquire results of the access point search in a case where the identification information acquired by the first acquisition unit before the issuance of the command by the command unit and the identification information acquired by the first acquisition unit after the issuance of the command by the command unit are not different.

3. The information processing apparatus according to claim 2, wherein
the first acquisition unit repeats the acquisition of the identification information until acquiring the identification information different from the identification information acquired before the issuance of the command by the command unit.

4. The information processing apparatus according to claim 1, further comprising a determination unit configured to determine whether or not a predetermined time has elapsed after the access point search performed the most recently based on the identification information acquired by the first acquisition unit before the issuance of the command by the command unit, wherein
in a case where the determination unit determines that a predetermined time has elapsed after the access point search performed the most recently, the second acquisition unit determines whether or not to acquire results of the access point search based on the identification information acquired by the first acquisition unit before the issuance of the command by the command unit and the identification information acquired by the first acquisition unit after the issuance of the command by the command unit, and
in a case where the determination unit determines that a predetermined time has not elapsed after the access point search performed the most recently, the command unit does not issue the command and the second acquisition unit acquires results of the access point search performed the most recently without performing the determination.

5. The information processing apparatus according to claim 1, wherein
the identification information is a tick count value indicating an elapsed time after the power source is turned on in the communication device and the tick count value is updated to a value indicating an elapsed time at the point in time of the completion of the access point search each time the search is completed.

6. The information processing apparatus according to claim 1, wherein
the identification information is information indicating the absolute time at the point in time of the completion of the access point search and the information indicating the time is updated to information indicating the time at the point in time of the completion of the access point search each time the search is completed.

7. The information processing apparatus according to claim 1, further comprising:
a display unit configured to display results of the access point search acquired by the second acquisition unit; and
a communication unit configured to communicate with the communication device via an access point selected by a user from among access points displayed on the display unit.

8. The information processing apparatus according to claim 1, controlling a communication device having a forming unit configured to form an image on a printing medium with a printing material.

9. A control method that is performed in an information processing apparatus that controls a communication device, the method comprising the steps of:
commanding the communication device to search for an access point to which the communication device can connect;
acquiring identification information indicating the completion of the access point search performed by the communication device; and
acquiring results of the access point search performed by the communication device in accordance with the command, wherein
results of the access point search are acquired based on the identification information acquired before the issuance of the command and the identification information acquired after the issuance of the command.

10. The control method according to claim 9, wherein
in a case where the identification information acquired before the issuance of the command and the identification information acquired after the issuance of the command are different, results of the access point search are acquired, and
in a case where the identification information acquired before the issuance of command and the identification information acquired after the issuance of the command are not different, results of the access point search are not acquired.

11. The control method according to claim 10, wherein
the acquisition of the identification information is repeated until the identification information different from the identification information acquired before the issuance of the command is acquired.

12. The control method according to claim 9, further comprising a step of determining whether or not a predetermined time has elapsed after the access point search performed the most recently based on the identification information acquired before the issuance of the command, wherein
in a case where it is determined that a predetermined time has elapsed after the access point search performed the most recently, results of the access point search are acquired based on the identification information acquired before the issuance of the command and the identification information acquired after the issuance of the command, and
in a case where it is determined that a predetermined time has not elapsed after the access point search performed the most recently, results of the access point search performed the most recently are acquired without issuing the command and without performing the determination.

13. The control method according to claim 9, wherein
the identification information is a tick count value indicating an elapsed time after the power source is turned on in the communication device and the tick count value is updated to a value indicating an elapsed time at the point in time of the completion of the access point search each time the search is completed.

14. The control method according to claim 9, wherein
the identification information is information indicating the absolute time at the point in time of the completion of the access point search and the information indicating the absolute time is updated to information indicating the absolute time at the point in time of the completion of the access point search each time the search is completed.

15. The control method according to claim 9, further comprising the steps of:
displaying acquired results of the access point search; and
communicating with the communication device via an access point selected by a user from among the displayed access points.

16. The control method according to claim 9, being performed in an information processing apparatus that controls a communication device having a forming unit configured to form an image on a printing medium with a printing material.

17. A non-transitory computer readable storage medium storing a program for causing a computer to perform a control method that is performed in an information processing apparatus that controls a communication device, the method comprising the steps of:
commanding the communication device to search for an access point to which the communication device can connect;
acquiring identification information indicating the completion of the access point search performed by the communication device; and
acquiring results of the access point search performed by the communication device in accordance with the command, wherein
results of the access point search are acquired based on the identification information acquired before the issuance of the command and the identification information acquired after the issuance of the command.
